(19) United States
(12) Patent Application Publication
(10) Pub. No.: US 2011/0309644 A1
(43) Pub. Date: Dec. 22, 2011

(54) LATCH STRIKER WITH INTEGRAL LIGHT MECHANISM

(76) Inventors: William R. Gentile, Rochester Hills, MI (US); Jason Reznar, Redford, MI (US); Glen G. Breault, Hartland, MI (US)

(21) Appl. No.: 13/037,771

(22) Filed: Mar. 1, 2011

Related U.S. Application Data
(60) Provisional application No. 61/309,234, filed on Mar. 1, 2010.

(51) Int. Cl. E05B 15/02; B60Q 3/06

(52) U.S. Cl. 292/340; 362/488

(57) ABSTRACT

A latch striker may be used in a vehicle to hingedly attach a door, such as a glove box door to an instrument panel of a vehicle such that the door may be selectively opened and closed. The latch striker of the present embodiment may comprise a body, a latch bar attached to the body at an end of the body. The latch bar is capable of removably securing to a catch mechanism of the vehicle. The latch striker may further comprise a mounting device formed in a portion of the body substantially opposite the end of the body, the mounting device is capable of attaching to the vehicle, and a light mechanism secured to the body.

### CROSS-REFERENCE TO RELATED APPLICATION

This application claims benefit from U.S. Provisional Patent Application No. 61/309,234, entitled “Latch Striker with Integral Light Mechanism,” filed on Mar. 1, 2010, which is hereby incorporated in its entirety by reference.

### FIELD OF THE INVENTION

The present invention is generally related to latch strikers and, more particularly, to a latch striker with an integral light mechanism.

### BACKGROUND

A variety of latching mechanisms have been used within the automotive industry for releasably coupling various movable components to the vehicle body. For example, latches L may often be used for releasably coupling doors (e.g., passenger doors, liftgate, hood, deck lid, trunk, glove box, etc.) to vehicles. In order to keep a door of the vehicle in a closed position, a latching mechanism may be provided.

The latching mechanisms L may generally be operable in a latched mode to secure the door to the vehicle body and in an unlatched mode where the door may be freely movable relative to the vehicle body. Typically, the latching mechanisms may include a latch L that may engage a striker S when the door is in a closed position. The latch may typically be secured near an edge of the door, and a striker S may typically be secured to the vehicle body.

Generally, a glove box door or handle H may be provided to close an opening, such as a glove box or storage area, in an instrument panel P of a vehicle. The glove box door may be hingedly mounted to the instrument panel P to allow for pivotal movement between a closed position and an open position. In order to keep the door or handle H of the glove box in the closed position, a latching mechanism may be provided.

The latching mechanism may include a striker S to be mounted to the instrument panel P structure. As seen in FIGS. 1 and 3, striker S may include a latch bar B for the glove box latch to “strike” and close around to keep the glove box door in a closed position. Striker S may also include a mounting device WN for fixing the striker S to the instrument panel P facing the surface of the door. The mounting device WN may include a fastener and a nut.

A claw mechanism L may also be mounted to the glove box door. The claw mechanism may trap or catch the latch bar B of the striker S when the glove box door is in the closed position. Striker S may be utilized for releasably coupling glove box doors and the like. Often, however, it may be desirous to have a means to illuminate the inner compartments of these structures as they can be dark. The means to illuminate moreover, must not interfere with the operation of the striker and must be compact enough to fit within the tight spaces available.

### SUMMARY

A latch striker for a vehicle is disclosed. The latch striker of the present embodiment may comprise a body, a latch bar attached to the body at an end of the body. The latch bar is capable of removably securing to a catch mechanism of the vehicle. The latch striker may further comprise a mounting device formed in a portion of the body substantially opposite the end of the body, the mounting device is capable of attaching to the vehicle, and a light mechanism secured to the body.

In an alternative embodiment, a latch striker is disclosed. The latch striker may comprise a first body portion, a second body portion integrally attached with the first body portion, a latch bar attached to the first body portion. The latch bar is capable of removably securing to a catch mechanism of a vehicle. The latch striker may further comprise a mounting device formed in the second body portion, where the mounting device is capable of attaching to the vehicle, and a light mechanism mounting device formed in the first body portion.

Finally in yet another alternative embodiment, a latch striker for a vehicle is disclosed. The latch striker may comprise a first body portion, a second body portion attached to the first body, where the first body portion is at an angle relative to the second body portion, a latch bar attached to the first body portion, the latch bar capable of removably securing to a catch mechanism, a light mechanism mounting device integrally formed with the first body portion, and a light mechanism secured to the light mechanism mounting device.

### DESCRIPTION OF THE DRAWINGS

Objects and advantages together with the operation of the invention may be better understood by reference to the following detailed description taken in connection with the following illustrations, wherein:

FIG. 1 is a perspective view of a prior art glove box striker.

FIG. 2 is a perspective view of the prior art glove box striker of FIG. 1 in use.

FIG. 3 is a perspective view of the prior art glove box striker of FIG. 1 in use.

FIG. 4 is a perspective view of a striker.

FIG. 5 is a front view of the striker of FIG. 4.

FIG. 6 is a side view of the striker of FIG. 4.

FIG. 7 is a perspective view of a latch striker with integral light mechanism.

FIG. 8 is a side view of the latch striker with integral light mechanism of FIG. 7.

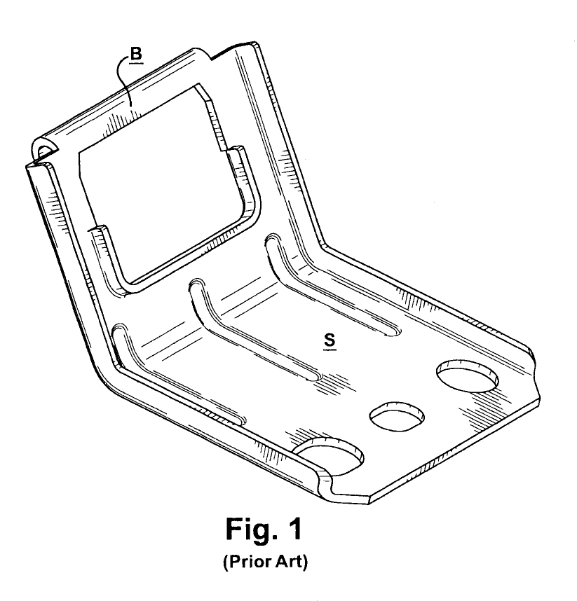

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

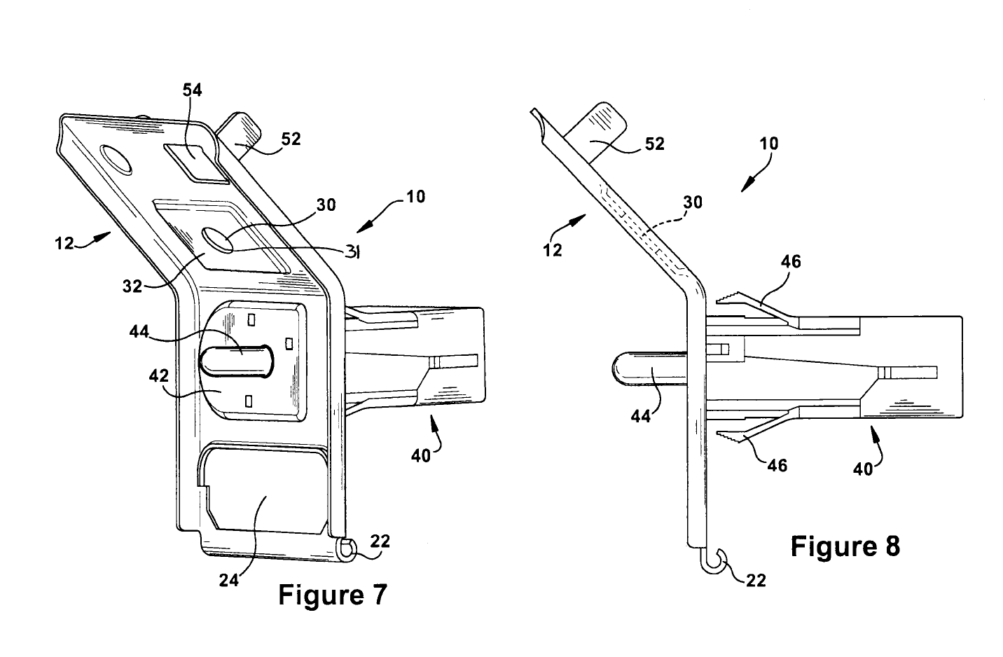

A latch striker with an integral light mechanism 10 is shown in FIGS. 7 and 8. The latch striker with integral light mechanism 10 may combine the function of a striker 12, with the capabilities of a lighting mechanism 40. This combined latch striker with integral light mechanism 10 may eliminate the need for additional space that may result in cost and space savings.

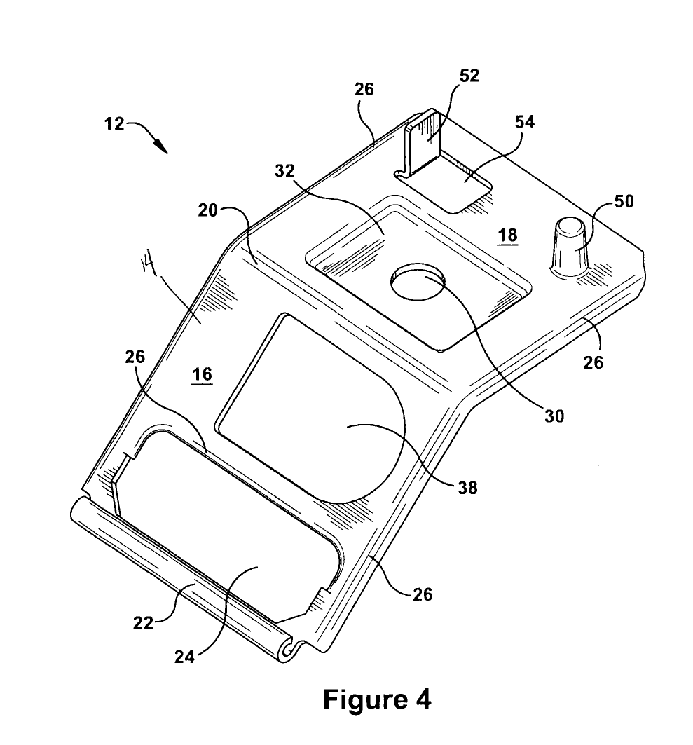

The latch striker with integral light mechanism 10 may include a striker 12 and a light mechanism 40; an example of which is shown in FIGS. 7 and 8. The striker 12 may include a body 14 that may serve as a mounting structure to mount to, for example, a vehicle, which can be seen in FIGS. 4-6. The body 14 may include an integrally formed first body portion or end 16, a second body portion or end 18, and a bend 20. As an alternative, instead of being an integrally formed body component 14, the two body portions 16, 18 may be separate pieces that may be secured to one another by any appropriate means, such as by welding, using adhesive, using mechanical fasteners, and the like.

The first end 16 may be of any appropriate shape or size, such as a generally square or rectangular shape, which is shown in FIG. 4. The second end 18 may also be of any appropriate shape or size, such as a generally square or rectangular shape, an example of which is shown in FIG. 4. The first end 16 and the second end 18 may each be of similarly shaped and sized configurations or of different shaped and sized configurations.

The bend 20 may include an angle A, an example of which is shown in FIGS. 4-6. The angle A of the bend 20 may be of any appropriate type or degree, such as an approximately 130-140 degree angle A, an example of which is specifically shown in FIG. 6. The bend 20 may be located at any appropriate position along the body 14 of the striker 12, such as in a generally central location of the body 14. For example, the bend 20 may be located between the first body portion 16 and the second body portion 18. The first body portion 16 may be located adjacent to and preferably at the angle A away from the second body portion 18, due to the bend 20. By way of a non-limiting example, the specific angle A of the bend 20 may assist with positioning the striker 12 such that the claw mechanism L of, for example, a glove box may latch and close around such striker 12. Additionally, the specific angle A of the bend 20 may assist the striker 12 in being fixed in the appropriate position to the instrument panel P.

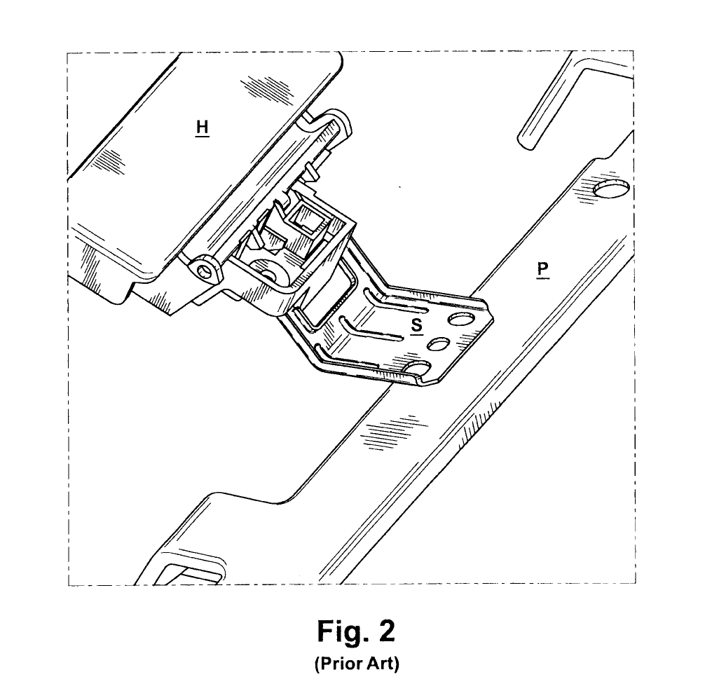

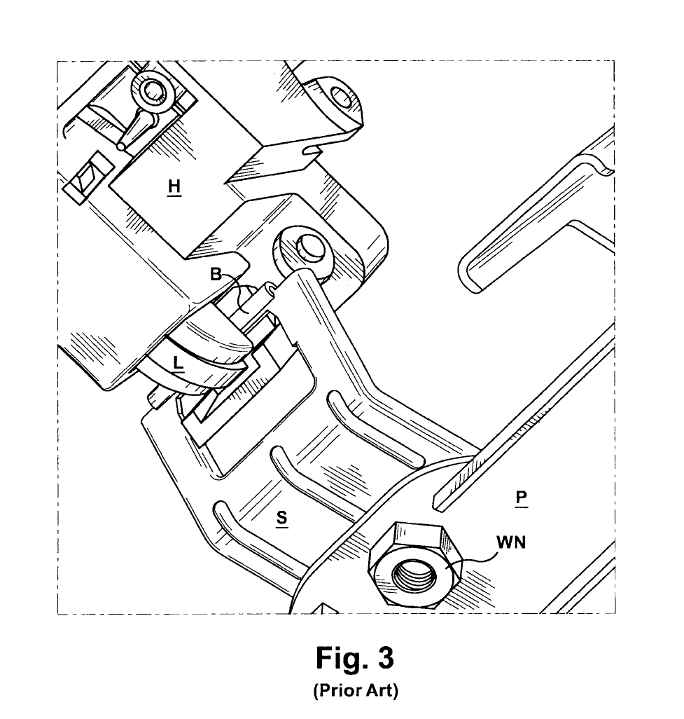

The first body portion 16 of the striker 12 may also include a latch bar 22 and a latch opening 24. The latch bar 22 may be of any appropriate size or shape, such as a substantially linear shape, solid cylindrical rod shape, or the like. For example, the latch bar 22 may form a general “C” shape in its profile, such as for example as shown in FIG. 6. In an embodiment, the latch bar may be integrally formed with the striker 12, see FIG. 4. Alternatively, the latch bar 22 may be a separate piece from the striker 12 that may be attached to the striker 12 by any appropriate means, such as by welding, using adhesive, using mechanical fasteners, and the like. The latch bar 22 may provide a catching mechanism whereby a glove box door may “strike” and close around the latch bar 22. An example of such a catching mechanism is illustrated in FIGS. 2 and 3.

The latch opening 24 of the striker 12 may provide room for a “claw” of the catching mechanism to catch and hold onto the latch bar 22. The latch opening 24 may be of any appropriate size or shape, such as a generally circular, square or rectangular shape. The latch opening 24 may be located at any appropriate position on the striker 12, such as adjacent the latch bar 22 on the first end 16.

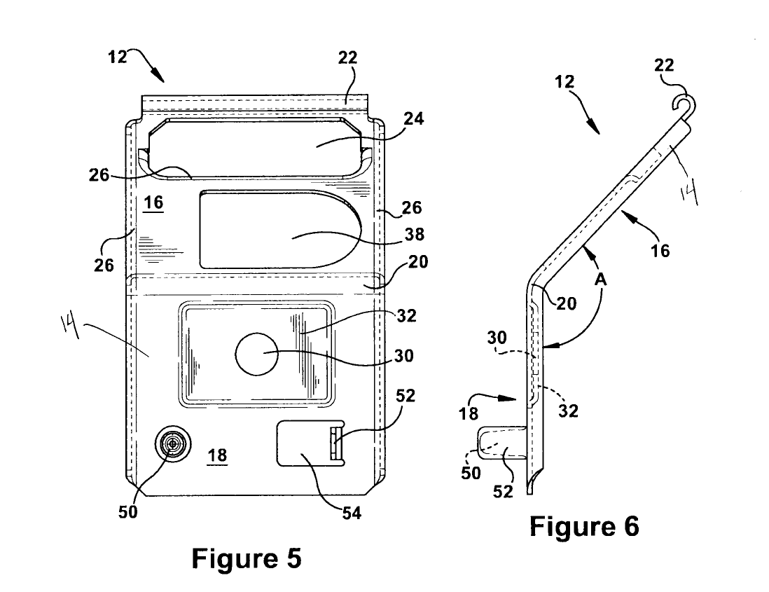

The striker 12 may also include a structural lip 26. The structural lip 26 may provide for additional strength for the striker 12. The structural lip 26 may be of any appropriate shape or size, such as a generally curved shape. The structural lip 26 may be located at any appropriate position on the striker 12. By way of a non-limiting example, the structural lip 26 may extend along an outer edge of the body 14 and along an inner edge of the latch opening 24, an example of which is shown in FIGS. 4 and 5. The structural lip 26 may be integrally formed with the body 14 of the striker 12. Alternatively, the structural lip 26 may be a separate piece from the body 14 and attached thereto by any appropriate means, such as by welding, using adhesive, using mechanical fasteners, and the like.

The second body portion 18 of the striker 12 may include an aperture 30. The aperture 30 may be of any appropriate size or shape, such as a generally rectangular, triangular, square or circular shape. The aperture 30 may be located at any appropriate position on the striker 12, such as being located at an approximate center of the second body portion 18. For example, the aperture 30 may be located adjacent the bend area 20, as shown in FIGS. 4 and 5. The aperture 30 may be integrally formed with the second body portion 18, or alternatively, may be subsequently formed in the second body portion 18 by additional processing.

The aperture 30 may also form a lip 31 located around the edge, whereby the lip may slightly protrude from the surface of the body 14. In addition, the striker 12 may include a raised portion or boss 32 on the opposite side of the body 14. The raised portion or boss 32 may be of any appropriate shape or size, such as a generally raised circular, square, triangular or rectangular shape. The raised portion or boss 32 may provide additional structural qualities around the aperture 30 of the striker 12.

In use, the aperture 30 of the striker 12 may be located adjacent an opening in the frame of an instrument panel P. A fastener (not shown) may be passed or extended through the aperture 30 of the striker 12 in order to mount and secure the latch striker 10 to a surrounding structure on the automobile. For example, the surrounding structure may be an instrument panel P of an automobile body or the like. The fastener (not shown) may be of any appropriate type or means, but is preferably a screw, bolt, or the like.

The striker 12 may also include a light mechanism opening 38, as shown in FIGS. 4 and 5. The light mechanism opening 38 may be of any appropriate shape or size, such as a generally circular, ovular, rectangular, square or triangular shape. For example, the light mechanism opening 38 may be of a correspondingly similar shape and size to that of the light mechanism 40. The light mechanism opening 38 may be located at any appropriate position on the striker 12, such as on the first end 16. For example, the light mechanism opening 38 may be located between the bend area 20 and the latch opening 24. The light mechanism opening 38 may be integrally formed with the first body portion 16, or alternatively, may be subsequently formed in the first body portion 16 by additional processing.

The light mechanism 40 may be of any appropriate shape, size, type or configuration. The light mechanism 40 may be located and secured within the light mechanism opening 38 by any appropriate means. For example, the light mechanism 40 may be secured via a frictional fit, fasteners, adhesives or the like. The light mechanism 40 may include a face 42, a switch 44 and at least one attachment feature 46, an example of which is shown in FIGS. 7 and 8. The light mechanism 40 may be an incandescent light, a light emitting diode (LED), or any other kind of light producing device.

The face 42 may be of any appropriate shape or size, such as of a generally planar configuration, whereby the face 42 may be generally flush with the striker body 14. The face 42 may be located at any appropriate position on the light mechanism 40, such as towards an end of the light mechanism 40, such as shown in FIG. 7. The switch 44 may be of any appropriate shape or size, such as a generally cylindrical or rectangular shape. The switch 44 may operate to activate or deactivate a light source (not shown). The switch 44 may be activated or deactivated by any appropriate means, such as by actuating (e.g., pushing or moving) the switch to one side.

The light mechanism 40 may also include attachment features 46. The attachment features 46 may be of any appropriate shape or size, such as clips, wings, tabs or other such protrusions. The attachment features 46 may be located at any appropriate position on the light mechanism 40, such as along any side of the light mechanism 40. The attachment features 46 may be utilized to secure the light mechanism 40 and thereby the striker 12 within the instrument panel P of the vehicle.

The light mechanism 40 may illuminate closed compartments, such as glove boxes in automobiles. In use, upon opening of the glove box door, the light mechanism 40 may be actuated, such as by the switch 44 being pushed or moved. Upon actuation, power may be produced to the light source, such as an incandescent bulb (not shown), a light emitting diode (LED), or any other kind of light producing device. The light emitted from the light source may, for example, illuminate the glove box compartment. Upon closing of the glove box door, the light mechanism 40 may be actuated such that it is deactivated thereby turning off the light source. At the same time, the striker 12 may maintain the door in the closed position. By way of a non-limiting example, the switch 44 may be actuated to an illuminated position upon opening of the door and may be actuated to an off position when the door is closed.

The second body portion 18 of the striker 12 may also include one or more locating features. These locating features may include a locating knob 50 and a locating tab 52. The locating knob 50 may be of any appropriate size or shape, such as a generally rectangular, cylindrical or cone like shape extending away from a surface of the striker 12. The locating knob 50 may be located at any appropriate position on the striker 12, such as being located on the second body portion 18, such as shown in FIGS. 4-6. In addition, the locating knob 50 may be located towards one side of the striker 12. The locating knob 50 may be capable of accepting a fastener (not shown) whereby the fastener (not shown) is capable of attaching the striker 12 to the vehicle, such as for example the instrument panel P.

The locating tab 52 may be of any appropriate size or shape, such as a generally square, triangular or rectangular shape that may extend away from a surface of the striker 12. The locating tab 52 may be located at any appropriate position on the striker 12, such as being located on the second body portion 18, such as shown in FIGS. 4-8. In addition, the locating tab 52 may be located towards an opposite side of the striker 12 as that of the locating knob 50. The locating tab 52 may extend outward in a similar direction away from the surface of the striker 12 as the locating knob 50. In addition, the locating knob 50 and locating tab 52 may extend in either direction away from the striker 12, whereby the knob 50 and tag 52 may both extend in the same direction or differing directions.

The striker 12 may also include a tab opening 54. The tab opening 54 may be of any appropriate shape or size, such as a rectangular, square or triangular shape. For example, the tab opening 54 may be of a correspondingly similar size and shape to the locating tab 52. The tab opening 54 may be located at any appropriate position on the striker 12, such as adjacent to the locating tab 52. The locating features 50, 52 may be utilized as an additional mounting structure or surface through which fasteners may be passed or extended to mount and secure the latch striker 10 to a body. By way of a non-limiting example, the locating tab 52 may be integrally formed with the second body portion 18. Alternatively, the tab 52 may be attached such as by welding, using adhesive, using fasteners or the like.

The utilization of the locating knob 50 and locating tab 52 may further reduce the amount of handling and eliminate the need for additional welding operations, thus resulting in further cost savings. It is to be understood that these locating features 50, 52 may be of any other appropriate shape or appropriate means and that there may be one or more locating features on the latch striker 10.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, the following is claimed:

1. A latch striker for a vehicle, the latch striker comprising:
a body;
a latch bar attached to the body at an end of the body, the latch bar capable of removably securing to a catch mechanism of the vehicle;
a mounting device formed in a portion of the body substantially opposite the end of the body, wherein the mounting device is capable of attaching to the vehicle; and
a light mechanism secured to the body.

2. The latch striker of claim 1, wherein the body comprises a first body portion and a second body portion attached to the first body portion.

3. The latch striker of claim 2, wherein the first body portion and the second body portion are integrally formed.

4. The latch striker of claim 2, wherein the latch bar is integrally formed with the first body portion.

5. The latch striker of claim 2, wherein the mounting device comprises:
a boss integrally formed in the second body portion, the boss having a surface; and
an aperture located on the surface of the boss.

6. The latch striker of claim 2, further comprising a light mechanism mounting device formed in the first body portion.

7. The latch striker of claim 6, wherein the light mechanism mounting device is integrally formed with the first body portion.

8. The latch striker of claim 7, wherein the light mechanism mounting device comprises an aperture sized to receive the light mechanism.

9. The latch striker of claim 1, wherein the light mechanism includes a mounting device capable of engaging the body.

10. The latch striker of claim 8, wherein the mounting device is selected from the group consisting of a protrusion, clip, wing, and tab.

11. A latch striker comprising:
a first body portion;
a second body portion integrally attached with the first body portion;
a latch bar attached to the first body portion, the latch bar capable of removably securing to a catch mechanism of a vehicle;
a mounting device formed in the second body portion, wherein the mounting device is capable of attaching to the vehicle;
a light mechanism mounting device formed in the first body portion; and
a light mechanism secured to the light mechanism mounting device.

12. The latch striker of claim 11, wherein the light mechanism further includes a switch, wherein the switch is actuated upon engagement of the latch bar with the catch mechanism of the vehicle.

13. The latch striker of claim 12, wherein the light mechanism comprises an attachment feature, wherein the attachment feature secures the light mechanism to the first body portion and is capable of securing the first body portion to a panel of the vehicle.

14. The latch striker of claim 13, wherein the attachment feature comprises a pair of clips.

15. The latch striker of claim 11, wherein the light mechanism mounting device comprises an aperture integrally formed in the first body portion.

16. A latch striker for a vehicle, the latch striker comprising:
a first body portion;
a second body portion attached to the first body, wherein the first body portion is at an angle relative to the second body portion;
a latch bar attached to the first body portion, the latch bar capable of removably securing to a catch mechanism of the vehicle;
a light mechanism mounting device integrally formed with the first body portion;
a light mechanism secured to the light mechanism mounting device; and
a locating device attached to said second body portion.

17. The latch striker of claim 16, wherein the locating device comprises a locating knob integrally formed with the second body portion.

18. The latch striker of claim 17, wherein the locating device further comprises a locating tab integrally formed in the second body portion.

19. The latch striker of claim 18, wherein the second body portion is securable to a vehicle utilizing the locating knob and locating tab.

20. The latch striker of claim 19, wherein the light mechanism comprises an attachment feature, wherein the attachment feature secures the light mechanism to the first body portion and is capable of securing the first body portion to a panel of the vehicle.
